(19) United States
(12) Patent Application Publication
(10) Pub. No.: US 2024/0213839 A1
(43) Pub. Date: Jun. 27, 2024

(54) STATOR OF AN ELECTRIC MACHINE

(71) Applicant: Robert Bosch GmbH, Stuttgart (DE)

(72) Inventors: Bastian Vogt, Backnang (DE); Daniel Kuehbacher, Stuttgart (DE); Daniel Gremmel, Hohenhameln (DE); Felix Bensing, Stuttgart (DE)

(21) Appl. No.: 18/557,637

(22) PCT Filed: Mar. 28, 2022
(86) PCT No.: PCT/EP2022/058102

§ 371 Date: Oct. 27, 2023

(30) Foreign Application Priority Data
Apr. 28, 2021 (DE) 10 2021 204 202.3

(51) Int. Cl. H02K 3/24; H02K 3/28; H02K 3/34; H02K 9/19; H02K 15/00

(52) U.S. Cl. CPC H02K 3/24; H02K 3/28; H02K 3/345; H02K 9/19; H02K 15/0087

(57) ABSTRACT

The invention relates to a stator (1) of an electric machine (23) having a stator axis (2) and having a laminated core (3) on which stator teeth (4) and stator slots (5) located between the stator teeth (4) are formed and which has a large number of laminations (6), wherein the stator teeth (4) are interconnected via an annular stator yoke (7), wherein a single conductor (9) or a conductor bundle (10) comprising a plurality of conductors (9), in particular a stack of flat-wire conductors, is provided in each of the stator slots (5) in order to form an electrical stator winding (8), wherein a plurality of support points (11) which are spaced apart from one another in the axial direction with respect to the stator axis (2) are formed in each of the stator slots (5) in order to clamp the conductor (9) or conductor bundle (10) in each stator slot (5), wherein at least one slot gap (19) is formed between the walls (4.2, 5.1) of each stator slot (5) and the conductor or conductor bundle (9, 10) arranged in the stator slot (5), which slot gap forms a slot gap channel (20) which extends in the axial direction and through which a cooling medium, in particular oil, can flow,
characterized in that
the support points (11) are each formed by twisting individual or a plurality of laminations (6) of the laminated core (3), in particular a group (12) or a plurality of groups (12) of laminations (6).

### BACKGROUND

The invention proceeds from a stator of an electric machine.

The invention relates to a stator of an electric machine from DE102019113785 A1, having a stator axis and having a laminated core on which stator teeth and stator slots located between the stator teeth are formed and which has a large number of laminations, wherein the stator teeth are interconnected via an annular stator yoke, wherein a single conductor or a conductor bundle comprising a plurality of conductors, in particular a stack of flat-wire conductors, is provided in each of the stator slots in order to form an electrical stator winding, wherein a plurality of support points which are spaced apart from one another in the axial direction with respect to the stator axis are formed in each of the stator slots in order to clamp the conductor or conductor bundle in each stator slot, wherein at least one slot gap is formed between the walls of each stator slot and the conductor or conductor bundle arranged in the stator slot, which slot gap forms a slot gap channel which extends in the axial direction and through which a cooling medium, in particular oil, can flow. The support points are each formed on a special lamella of the laminated core, referred to as a clamping stator lamination, in that a clamping contour comprising a plurality of clamping projections is provided in each case. The special lamellas differ from the other laminations of the laminated core. The conductor bundles must each be inserted into the stator slots in the axial direction with respect to the stator axis and moved through the clamping contours under the effect of clamping forces. This can damage the conductor bundles, especially their electrical insulation.

### SUMMARY

In contrast, the stator according to the invention has the advantage that the support points can be generated without special lamellas and the conductor bundles can be inserted into the stator slots during assembly without clamping forces. In this way, the manufacturing costs of the stator are reduced. It also prevents damage to the conductor bundles when they are inserted into the respective stator slots. According to the invention, this is achieved by forming the support points in each case by twisting individual or a plurality of laminations of the laminated core, in particular one group or several groups of laminations.

It is particularly advantageous if the respective support point is formed by at least two laminations, in particular by two groups of laminations, which are twisted in opposite directions by a certain angle of twist about the stator axis. In this way, the conductor or conductor bundle of the respective stator slot is clamped between two tooth flanks at the respective support point.

It is further advantageous if, by twisting the laminations in opposite directions to form the respective support point, support sections of the laminations are formed which project from opposite sides of the stator slot into the respective stator slot in order to clamp the conductor or conductor bundle between the support sections on clamping surfaces of the conductor or conductor bundle. Each support point is thus formed by at least two support sections which project into the stator slot from opposite sides of the respective stator slot and clamp the conductor or conductor bundle. In this way, the conductor or the conductor bundle can be supported centrally or centrically in the respective stator slot in the circumferential direction with respect to the stator axis.

It is particularly advantageous if the twisted laminations have the same recesses for forming the stator slots as the non-twisted laminations. The twisted laminations and the non-twisted laminations are identical, for example, so that the laminated core can be formed from a stack of the same or identical laminations and, in contrast to DE102019113785 A1, does not require a special lamella to form the support points.

It is very advantageous if the conductor or the conductor bundle of the respective stator slot has at least one raised, in particular electrically non-conductive protective layer at least on the clamping surfaces of the respective support point, which protective layer is formed in particular in the form of a cuff, sleeve-shaped tubular, clamp-shaped, U-shaped, strip-shaped, or flat strip-shaped. In this way, the conductors or conductor bundles are protected from mechanical damage caused by clamping between the protruding support sections of the laminations. For example, punching edges or burrs of the twisted laminations could damage a varnish insulation of the conductors. In particular, the electrically non-conductive protective layer can be used to achieve so-called slot insulation. The time-consuming insertion of a separate slot insulation, for example an insulation paper, in the stator slots can thus be omitted.

It is also advantageous if several protective layers of the same conductor or conductor bundle, in particular cuffs or sleeves, are interconnected via a web running in the direction of the conductor or conductor bundle, in particular to form a one-piece or two-piece component. In this way, the protective layers can be produced or attached to the conductor or conductor bundle particularly easily. The one-piece or two-piece component serves as so-called slot insulation and also provides a flow cross-section for the slot gap channel. The time-consuming insertion of a separate slot insulation, for example an insulation paper, in the stator slots can thus be omitted.

It is advantageous if the respective slot gap channel is interrupted or narrowed at the support points, with additional passages being provided in the laminations and/or in the protective layer and/or in the conductor or conductor bundle and/or between the conductors of the conductor bundle to eliminate or reduce the respective interruption or narrowing. In this way, the support points are designed in such a way that the cooling medium can flow through or around them in the slot gap channel. In addition, this keeps the pressure loss during the flow through the respective stator slot low.

It is also advantageous if the flow through the respective stator slot is continuous in the axial direction, since in this way particularly low pressure losses can be achieved during oil cooling of the stator.

It is also advantageous if the twisted laminations are fixed in the laminated core to prevent further twisting, in particular by joining laminations with a substance-to-substance bond, in particular welding. For example, the laminations of the laminated core are welded together. In this way, the support points in the laminated core are secured against unintentional further twisting, so that stable and permanently durable mounting of the conductors or conductor bundles in the laminated core is achieved.

The invention further relates to an electrical machine having a housing in which a stator according to the invention is arranged, the stator winding forming a winding head on each end face of the stator, a winding head cooling chamber accommodating the respective winding head being provided inside the housing on each end face of the stator for cooling the respective winding head, it being possible for the stator slots to be flowed through, starting from one of the two winding head cooling chambers, into the other winding head cooling chamber. In this way, particularly good cooling of the stator can be achieved.

In an advantageous manner, the respective winding head cooling chamber is bounded radially inwards with respect to the stator axis by an annular wall, in particular a sealing sleeve. In this way, the respective winding head cooling chamber can be sealed radially inwards.

### BRIEF DESCRIPTION OF THE DRAWINGS

An exemplary embodiment of the invention is shown in simplified form in the drawings and explained in further detail in the following description.

FIG. 1 shows a partial view of a stator of an electric machine according to the invention,

FIG. 2 a sectional view of the stator according to FIG. 1 with a conductor bundle mounted in one of the stator slots at several support points according to the invention,

FIG. 3 a view of a support point according to the invention as shown in FIG. 2,

FIG. 4 a view of a conductor bundle of the stator according to FIG. 1 to FIG. 3 with protective layers according to the invention for mounting the conductor bundle in the respective stator slot according to the invention,

FIG. 5 a sectional view of the stator for a cut along the line V-V according to FIG. 2,

FIG. 6 a sectional view of the stator for a cut along the line VI-VI according to FIG. 2, and

FIG. 7 a partial view of an electrical machine with the stator according to the invention as shown in FIG. 1 through FIG. 6.

### DETAILED DESCRIPTION

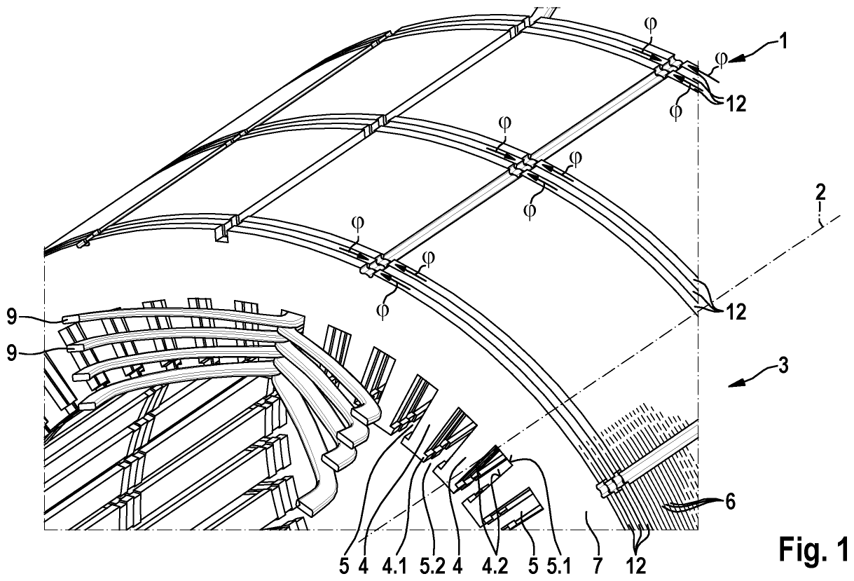

FIG. 1 shows a partial view of a stator of an electric machine according to the invention.

The stator 1 of an electric machine has a stator axis 2 and comprises a laminated core 3 on which stator teeth 4 and stator slots 5 located between the stator teeth 4 are formed and which is formed by a stack of laminations 6.

The stator teeth 4 are interconnected via an annular stator yoke 7 of the laminated core 3 and may have a tooth head 4.1. Either a single conductor 9 or a conductor bundle 10 comprising several conductors 9 may be provided in each of the stator slots 5 to form an electrical stator winding 8. To illustrate the invention, FIG. 1 shows a conductor bundle 10 in only one of the stator slots 5.

The conductors 9 of the stator 1 can each be designed as a flat wire conductor, each of which has a square, in particular rectangular, conductor cross-section. Furthermore, the conductors 9 of the stator 1 can each be formed as hairpin or as I-pin conductor elements. For example, the conductors 9 are coated with an insulating varnish in a known manner.

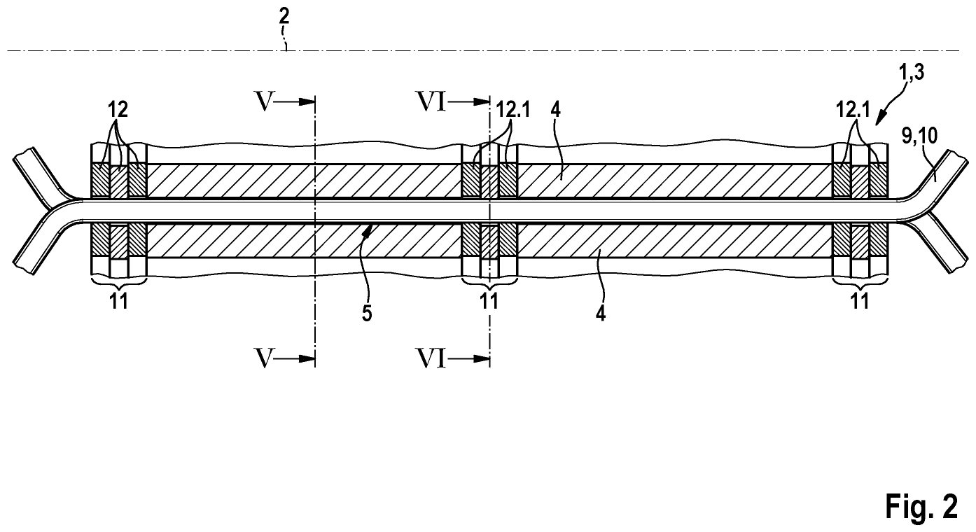

FIG. 2 shows a sectional view of the stator according to FIG. 1 with a conductor bundle mounted in one of the stator slots at several support points according to the invention.

As shown in FIG. 2, several, for example three, support points 11 spaced apart from one another in the axial direction with respect to the stator axis 2 are formed in each of the stator slots 5 for clamping, restraining, or supporting the conductor 9 or conductor bundle 10 located in the respective stator slot 5.

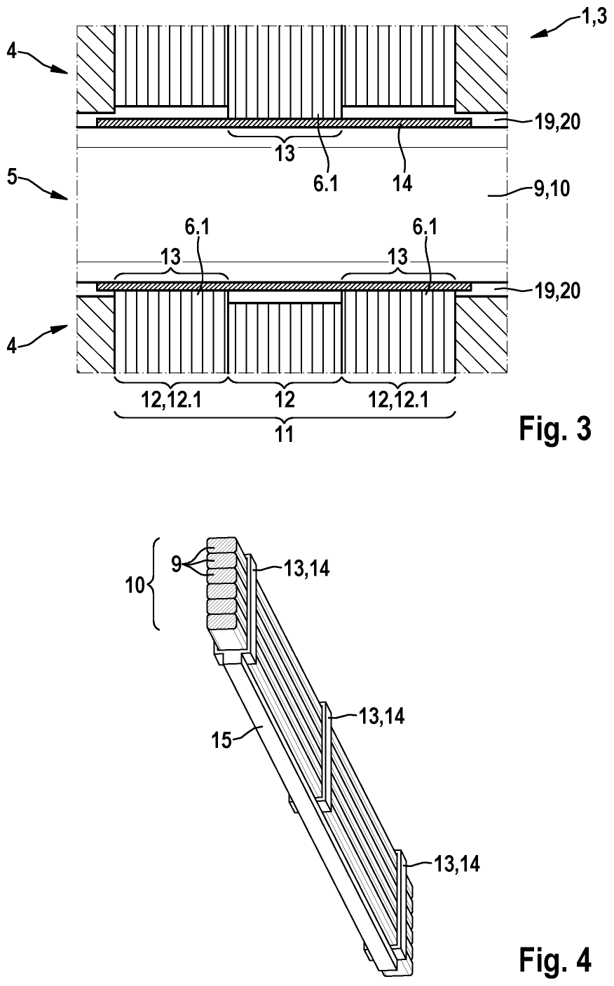

FIG. 3 shows a view of a support point according to the invention as shown in FIG. 2.

According to the invention, it is provided that the support points 11 are each formed by the twisting of individual or a plurality of laminations 6 of the laminated core 3, for example of one group 12 each or of several groups 12 of adjacent laminations 6. To form a single one of the support points 11, the twisted laminations 6 are twisted relative to the other laminations 6 of the laminated core 3 about the stator axis 2, for example by a certain twisting angle [symbol] .

The respective support point 11 is formed by at least two laminations 6, in particular by two groups 12 of laminations 6, which are twisted in opposite directions by the determined twisting angle Φ about the stator axis 2. According to the exemplary embodiment, the laminations 6 of a first group 12 are divided by the laminations 6 of a second group 12 into two subgroups 12.1 spaced apart in the axial direction, the second group being arranged between the two subgroups 12.1 of the first group 12 of laminations 6.

Between the support points 11 according to the invention, the conductor 9 or the conductor bundle 10 of the respective stator slot 5 is freely suspended, i.e., without contact with the laminated core 3. The conductor 9 or the conductor bundle 10 of the respective stator slot 5 is thus in contact with the laminated core 6 only at the support points 11.

The twisted laminations 6 have, for example, the same recesses for forming the stator slots 5 as the non-twisted laminations 6. For example, the twisted laminations 6 and the non-twisted laminations 6 are identical in design, so that the laminated core 3 is formed from a stack of identical or similar laminations 6 and does not require a special lamella to form the support points 11.

By twisting the laminations 6 in opposite directions to form the respective support point 11, support sections 6.1 of the laminations 6 are formed which project from opposite sides of the stator slot 5 into the respective stator slot 5 to clamp the conductor 9 or conductor bundle 10 between the support sections 6.1 at clamping surfaces 13 of the conductor 9 or conductor bundle 10.

The twisted laminations 6 can be fixed in the laminated core 3 to prevent further twisting, for example by joining laminations 6 with a substance-to-substance bond. For example, the laminations 6 of the laminated core 3 are welded together so that stable and permanently retainable support points 11 are formed in the laminated core 3.

The conductor 9 or the conductor bundle 10 of the respective stator slot 5 has, at least at the clamping surfaces 13 of the respective support point 11, at least one protective layer 14 which is raised with respect to the conductor 9 or conductor bundle 10 and is, for example, electrically non-conductive, and which is formed, for example, in the shape of a cuff, sleeve-shaped, tubular, clamp-shaped, U-shaped, strip-shaped, or flat strip-shaped. The raised protective layer 14 can be implemented only at the clamping surfaces 13 or can enclose the conductor 9 or the conductor bundle 10 beyond the clamping surfaces 13, at least in sections, for example single or multiple enclosures. Furthermore, the protective layer 14 can be a separate part or an additional layer applied to the conductor 9 or conductor bundle 10, in particular an injection molding or coating. According to the exemplary embodiment, the protective layer 14 is formed as a fully enclosing cuff or sleeve.

The following steps are carried out to produce the stator 1 according to the invention:
a) Stacking the laminations 6 to form the laminated core 3,
b) Axial insertion of the conductors 9 or the conductor bundles 10, which are provided in particular with protective layers 14, into the respective stator slots 5,
c) According to the invention, individual or a plurality of laminations 6 of the laminated core 3, in particular one group 12 or several groups 12 of adjacent laminations 6, are twisted to form several support points 11 per stator slot 5,
d) Fixing the twisted laminations 6 in the laminated core 3 against further twisting, in particular by substance-to-substance bonding, for example welding, the laminations 6 of the laminated core 3 to form a torsionally rigid laminated core 3,
e) Restricting conductor ends of conductors 9 and connecting the conductors 9 to the stator winding 8.

FIG. 4 shows a view of a conductor bundle of the stator according to FIG. 1 to FIG. 3 with protective layers according to the invention for mounting the conductor bundle in the respective stator slot according to the invention.

According to FIG. 4, it can be provided that several protective layers 14 of the same conductor 9 or conductor bundle 10, for example several cuffs or sleeves, are interconnected via a web 15 running in the direction of the conductor 9 or conductor bundle 10, for example to form a one-piece or two-piece component. The web 15 can be arranged in the respective stator slot 5 in a slot 5.2 arranged between the tooth heads 4.1.

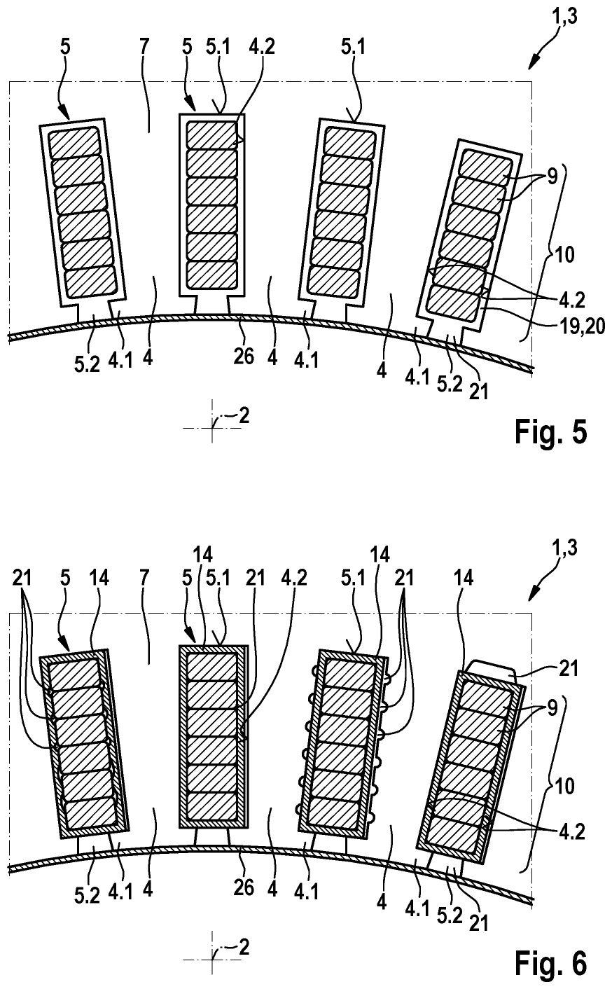

FIG. 5 shows a sectional view of the stator for a cut between two support points along the line V-V according to FIG. 2.

Between the walls of the respective stator slot 5 and the conductor 9 or conductor bundle 10 arranged in the stator slot 5 there is at least one slot gap 19 which forms a slot gap channel 20 extending in the axial direction through which a cooling medium, for example oil, can flow. For example, the conductor 9 or the conductor bundle 10 is mounted centrally in the respective stator slot 5 in such a way that three slot gaps 19 are formed in the stator slot 5 outside the support points 11, namely two slot gaps 19 on the tooth flanks 4.2 of the respective stator slot 5 and one slot gap 19 on a slot base 5.1. As a result, the cross-section of the slot gap channel 20 in the respective stator slot 5 is U-shaped.

FIG. 6 shows a sectional view of the stator for a cut through a support point along line VI-VI of FIG. 2.

It can be seen from FIG. 3 and FIG. 6 that the slot gap channel 20 of the respective stator slot 5 is interrupted or narrowed at the support points 11 in each case. Therefore, additional passages 21 are provided in the laminations 6 and/or in the protective layer 14 and/or in the conductor 9 or conductor bundle 10 and/or between the conductors 9 of the conductor bundle 10 to cancel or reduce the respective interruption or constriction. In FIG. 6, different variants of the passages 21 are shown as examples in each of the stator slots 5. For example, the passages 21 are provided at each support point 11 of the respective stator slot 5, so that the respective stator slot 5 can be flowed through continuously in the axial direction.

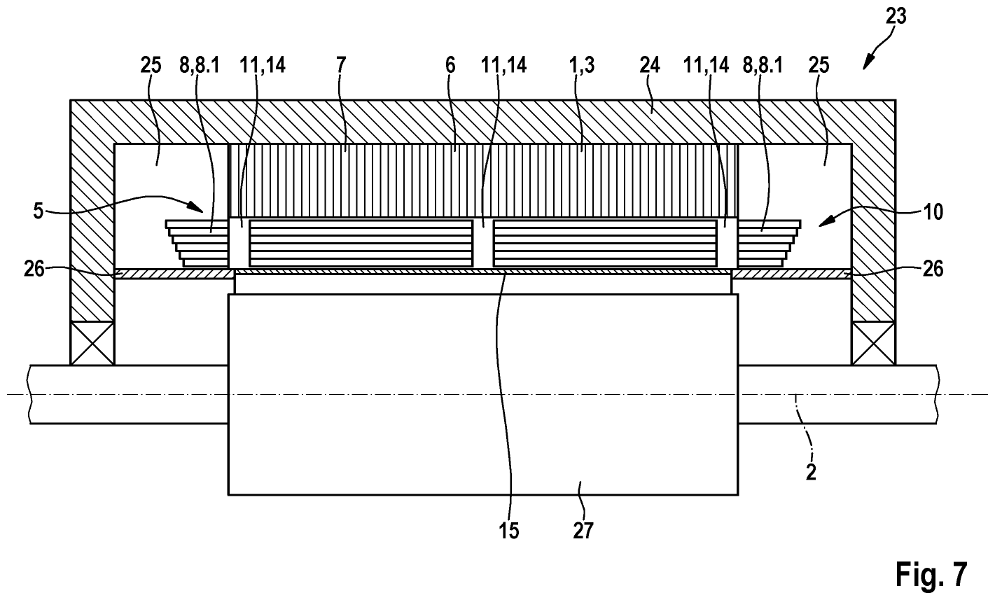

FIG. 7 shows a partial view of an electrical machine with the stator according to FIG. 1 through FIG. 6.

The electric machine 23 has a housing 24 in which a stator 1 according to the invention is arranged. The stator winding 8 forms a winding head 8.1 at each end face of the stator 1. Within the housing 24, a winding head cooling chamber 25 accommodating the respective winding head 8.1 is provided at each end face of the stator 1 for cooling the respective winding head 8.1. In this case, the stator slots 5 of the stator 1 can be flowed through starting from one of the two winding head cooling chambers 25 into the other winding head cooling chamber 25, for example in parallel, in series, or with a combination of parallel and in series. The respective winding head cooling chamber 25 is bounded radially inwards with respect to the stator axis 2 by an annular wall 26, for example a sealing sleeve. The sealing sleeve 26 may, for example, extend into an air gap formed between the stator 1 and a rotor 27 of the electric machine 23 to form a so-called gap tube, and project through the gap in the axial direction with respect to the stator axis 2.

1. A stator (1) of an electric machine (23) having a stator axis (2) and having a laminated core (3) on which stator teeth (4) and stator slots (5) located between the stator teeth (4) are formed and which has a large number of laminations (6), wherein the stator teeth (4) are interconnected via an annular stator yoke (7), wherein a single conductor (9) or a conductor bundle (10) comprising a plurality of conductors (9) is provided in each of the stator slots (5) in order to form an electrical stator winding (8), wherein a plurality of support points (11) which are spaced apart from one another in an axial direction with respect to the stator axis (2) are formed in each of the stator slots (5) in order to clamp the conductor (9) or conductor bundle (10) in each stator slot (5), wherein at least one slot gap (19) is formed between walls (4.2, 5.1) of each stator slot (5) and the conductor or conductor bundle (9, 10) arranged in the stator slot (5), which slot gap forms a slot gap channel (20) which extends in the axial direction and through which a cooling medium can flow,
wherein
the support points (11) are each formed by twisting individual or a plurality of laminations (6) of the laminated core (3).

2. The stator according to claim 1, wherein a respective support point (11) is formed by at least two laminations (6).

3. The stator according to claim 14, wherein by twisting the laminations (6) in opposite directions to form the respective support point (11), support sections (6.1) of the laminations (6) are formed which project into the respective stator slot (5) from opposite sides of the stator slot (5) to clamp the conductor (9) or conductor bundle (10) between the support sections (6.1) at clamping surfaces (13) of the conductor (9) or conductor bundle (10).

4. The stator according to claim 3, wherein the conductor (9) or the conductor bundle (10) of the respective stator slot (5) has at least one raised protective layer (14) at least on the clamping surfaces (13) of the respective support point (11).

5. The stator according to claim 4, wherein several protective layers (14) of the same conductor (9) or conductor bundle (10) are interconnected via a web (15) running in a direction of the conductor (9) or conductor bundle (10).

6. The stator according to claim 1, wherein the respective slot gap channel (20) is interrupted or narrowed at the support points (11) in each case, additional passages (21) being provided in the laminations (6) and/or in a protective layer (14) and/or in the conductor (9) or conductor bundle (10) and/or between the conductors (9) of the conductor bundle (10) in order to cancel or reduce the respective interruption or narrowing.

7. The stator according to claim 1, wherein the respective stator slot (5) can be flowed through continuously in the axial direction.

8. The stator according to claim 1, wherein the twisted laminations (6) are fixed in the laminated core (3) against further twisting.

9. An electric machine (23) having a housing (24) in which a stator (1) according to claim 1 is arranged, wherein the stator winding (8) forms a winding head (8.1) on each end face of the stator (1), a winding head cooling chamber (25), which accommodates the respective winding head (8.1) is provided inside the housing (24) on each end face of the stator (1) for cooling the respective winding head (8.1), it being possible for the flow to pass through the stator slots (5), starting from one of the two winding head cooling chambers (25), into the other winding head cooling chamber (25).

10. The electric machine according to claim 9, wherein a respective winding head cooling chamber (25) is bounded radially inwards with respect to the stator axis (2) by an annular wall (26).

11. A method of manufacturing a stator according to claim 1, comprising the steps of:
a) Stacking of laminations (6) to form the laminated core (3),
b) Axial insertion of the conductors (9) or conductor bundles (10) into the respective stator slots (5),
c) Twisting of individual or a plurality of laminations (6) of the laminated core (3) to form several support points (11) per stator slot (5),
d) Fixing the twisted laminations (6) in the laminated core (3) to prevent further twisting,
e) Setting conductor ends of the conductors (9) and connecting the conductors (9) to the stator winding (8).

12. The stator according to claim 1, wherein the conductor bundle (10) includes a stack of flat-wire conductors.

13. The stator according to claim 1, wherein the cooling medium is oil.

14. The stator according to claim 2, wherein a respective support point (11) is formed by two groups (12) of laminations (6), which are twisted in opposite directions by a certain angle of twist (Φ) about the stator axis (2).

15. The stator according to claim 4, wherein the protective layer (14) is formed in the shape of a cuff, is sleeve-shaped, tubular, clamp-shaped, U-shaped, strip-shaped, or flat strip-shaped.

16. The stator according to claim 8, wherein the twisted laminations (6) are fixed in the laminated core (3) against further twisting by welding.

17. The electric machine according to claim 10, wherein the annular wall (26) is a sealing sleeve.

18. The method according to claim 11, further comprising providing the conductors (9) or conductor bundles (10) with protective layers (14).

19. The method according to claim 11, wherein twisting of individual or a plurality of laminations (6) of the laminated core (3) includes twisting one group (12) or several groups (12) of adjacent laminations (6).

20. The method according to claim 11, wherein fixing the twisted laminations (6) in the laminated core (3) to prevent further twisting, includes joining the laminations (6) to form a torsionally rigid laminated core (3).
